(19) United States
(12) Patent Application Publication
(10) Pub. No.: US 2011/0280250 A1
(43) Pub. Date: Nov. 17, 2011

(54) Semiconductor integrated circuit system and packet transmission control method in semiconductor integrated circuit

(75) Inventor: Hiroaki Inoue, Tokyo (JP)

(73) Assignee: NEC Corporation, Tokyo (JP)

(21) Appl. No.: 13/137,077

(22) Filed: Jul. 19, 2011

Related U.S. Application Data
(63) Continuation of application No. PCT/JP2011/058314, filed on Mar. 31, 2011.

(30) Foreign Application Priority Data
Apr. 6, 2010 (JP) 2010-087876

(51) Int. Cl. H04L 12/56

(52) U.S. Cl. 370/401

(57) ABSTRACT

A semiconductor integrated circuit includes: a plurality of cores connected with each other via an interconnection network; and a plurality of routers arranged on the interconnection network. Each router includes a transfer table, and each entry of the transfer table designates an output destination of a packet matching a match condition. The each router searches the transfer table upon receiving a reception packet, and, when there is a hit entry matching the reception packet in the transfer table, transfers the reception packet to an output destination designated by the hit entry. The path control circuit dynamically determines a transmission path of a packet from a source core to a destination core, and instructs each router on the determined transmission path to set the transfer table so that a packet transmission is carried out along the determined transmission path.

### CROSS-REFERENCE TO RELATED APPLICATION

This is continuation of International Application No. PCT/JP2011/58314 filed on Mar. 31, 2011.

### TECHNICAL FIELD

The present invention relates to a packet transmission control technique in a semiconductor integrated circuit including a plurality of cores connected with each other via an interconnection network.

### BACKGROUND ART

A semiconductor integrated circuit including a plurality of cores connected with each other via an interconnection network is known (for example, refer to Patent literature 1 (JP-A-Heisei 05-342184), Patent literature 2 (JP 2007-505383T), and Patent literature 3 (JP 2009-116872A)). Unlike a bus method, in a case of the interconnection network, a packet transmission between cores is realized by using a switching device called a router. A packet transmission path between cores is often preliminarily determined to be fixed. In that case, the router carries out the packet transmission in accordance with the preliminarily determined fixed path.

### CITATION LIST

### Patent Literature

Patent literature 1: JP-A-Heisei 05-342184
Patent literature 2: JP2007-505383T
Patent literature 3: JP2009-116872A

### SUMMARY OF INVENTION

When the packet transmission path is preliminarily fixed in the interconnection network, ability of the interconnection network cannot be utilized sufficiently. To sufficiently utilize the interconnection network, it is desired that the packet transmission path is dynamically and flexibly controllable.

An object of the present invention is to provide a useful technique able to dynamically control a packet transmission path in a semiconductor integrated circuit including a plurality of cores connected with each other via an interconnection network.

In one aspect of the present invention, a semiconductor integrated circuit system is provided. The semiconductor integrated circuit system includes: a semiconductor integrated circuit; and a path control circuit. The semiconductor integrated circuit includes: a plurality of cores connected with each other via an interconnection network; and a plurality of routers arranged on the interconnection network. Each of the plurality of routers includes a transfer table, and each entry of the transfer table designates an output destination of a packet which matches a match condition. The each router searches the transfer table upon receiving a reception packet, and, when there is a hit entry which matches the reception packet in the transfer table, transfers the reception packet to an output destination designated by the hit entry. The plurality of cores includes a source core and a destination core. The path control circuit dynamically determines a transmission path of a packet from the source core to the destination core, and instructs each router on the determined transmission path to set the transfer table so that a packet transmission can be carried out along the determined transmission path.

In another aspect of the present invention, a packet transmission control method in a semiconductor integrated circuit is provided. The semiconductor integrated circuit includes: a plurality of cores connected with each other via an interconnection network; and a plurality of routers arranged on the interconnection network. Each of the plurality of routers includes a transfer table, and each entry of the transfer table designates an output destination of a packet which matches a match condition. The each router searches the transfer table upon receiving a reception packet, and, when there is a hit entry which matches the reception packet in the transfer table, transfers the reception packet to an output destination designated by the hit entry. The plurality of cores includes a source core and a destination core. A packet transmission method according to the present invention includes: (A) dynamically determining a transmission path of a packet from the source core to the destination core; (B) instructing each router on the determined transmission path to set the transfer table so that a packet transmission can be carried out along the determined transmission path; and (C) the each router carrying out the packet transmission based on the transfer table.

According to the present invention, a packet transmission path can be dynamically controlled in a semiconductor integrated circuit including a plurality of cores connected with each other via an interconnection network.

### BRIEF DESCRIPTION OF DRAWINGS

The above and other objects, advantages and features of the present invention will be more apparent from the following description of certain preferred exemplary embodiments taken in conjunction with the accompanying drawings, in which:

FIG. 1 is a block diagram schematically showing a configuration of a semiconductor integrated circuit system according to exemplary embodiments of the present invention;

FIG. 2 is a flowchart showing an operation of the semiconductor integrated circuit system according to the exemplary embodiments of the present invention;

FIG. 3 is a block diagram showing a configuration example of a semiconductor integrated circuit system according to a first exemplary embodiment of the present invention;

FIG. 4 is a conceptual view showing a configuration example of a packet in the first exemplary embodiment;

FIG. 5 is a lock diagram showing a configuration example of a router in the first exemplary embodiment;

FIG. 6 is a conceptual view showing one example of a transmission table in the first exemplary embodiment;

FIG. 7 is a block diagram showing a configuration example of a path control circuit in the first exemplary embodiment;

FIG. 8 is a conceptual view showing one example of a setting entry table in the first exemplary embodiment;

FIG. 9 conceptually shows one example of an operation of the router in the first exemplary embodiment;

FIG. 10 conceptually shows another example of an operation of the router in the first exemplary embodiment;

FIG. 11 conceptually shows still another example of operation of the router in the first exemplary embodiment;

FIG. 12 conceptually shows one example of an operation of the semiconductor integrated circuit in the first exemplary embodiment;

FIG. 13 conceptually shows another example of an operation of the semiconductor integrated circuit in the first exemplary embodiment;

FIG. 14 is a block diagram showing a configuration example of a semiconductor integrated circuit system according to a second exemplary embodiment of the present invention; and

FIG. 15 is a conceptual view showing one example of a transmission table in the second exemplary embodiment.

### DESCRIPTION OF EXEMPLARY EMBODIMENTS

Referring to attached drawings, exemplary embodiments of the present invention will be described.

### 1. Outline

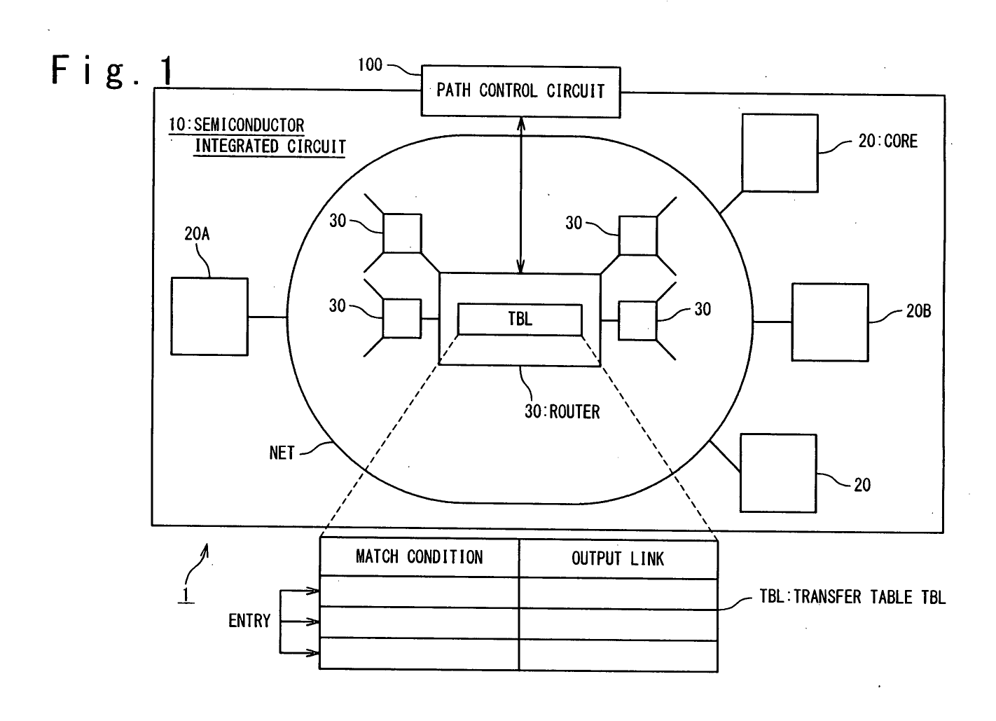

FIG. 1 schematically shows a configuration of a semiconductor integrated circuit system 1 according to the exemplary embodiments of the present invention. The semiconductor integrated circuit system 1 includes a semiconductor integrated circuit 10 and a path control circuit 100. The semiconductor integrated circuit 10 is a one-body semiconductor chip or semiconductor package. The path control circuit 100 dynamically controls a packet transmission path in the inside of the semiconductor integrated circuit 10. The path control circuit 100 may be incorporated inside the semiconductor integrated circuit 10 and may be provided separately from the semiconductor integrated circuit 10.

More specifically, the semiconductor integrated circuit 10 includes an interconnection network NET, a plurality of cores 20, and a plurality of routers 30. The plurality of cores 20 is connected with each other via the interconnection network NET. The plurality of routers 30 is arranged on the interconnection network NET. Each router 30 is connected to the adjacent routers 30 or the core 20 via a link.

The core 20 is a functional circuit such as a CPU (Central Processing Unit), an operational circuit, a memory control circuit, a memory, an I/O control circuit, an I/O, an on-chip memory control circuit, an on-chip memory, and a power-source/clock control circuit or the like.

Each of the routers 30 has a function to transfer a received packet. To be more specifically, each router 30 has a transfer table TBL. The transfer table TBL has transfer entries, the number of the transfer entries being equal to or more than 0 (zero). Each of the transfer entries indicates a correspondence relationship between a “match condition” and an “output link”. The “match condition” includes packet identification information used for identifying a packet. For example, the packet identification information includes information of a packet source, information of a packet address, a type of a packet, and the like. The “output link” indicates a link (an output destination) to which a packet matching the “match condition” has to be outputted. That is, each of the transfer entries designates the output destination of the packet matching the match condition. When having received a packet, the router 30 searches the transfer table TBL by using information of the received packet as a search key. In the case where there is a transfer entry (a hit entry) matching the received packet in the transfer table TBL, the router 30 transfers the received packet to an output destination designated by the hit entry. In this manner, the router 30 can carry out a packet transfer process based on its own transfer table TBL.

In the present exemplary embodiment, the packet transmission path in the interconnection network NET is not fixed and is able to be dynamically and flexibly set. For this reason, the transfer table TBL of the each router 30 is rewritable, and the contents are dynamically and flexibly set. The path control circuit 100 is a circuit that carries out the design and the setting of the contents of the above-mentioned transfer table TBL. The path control circuit 100 carries out centralized control of the transfer tables TBL of all the routers 300. Accordingly, the path control circuit 100 can dynamically set the contents of the transfer table TBL of each of the routers 30 based on the situation demands.

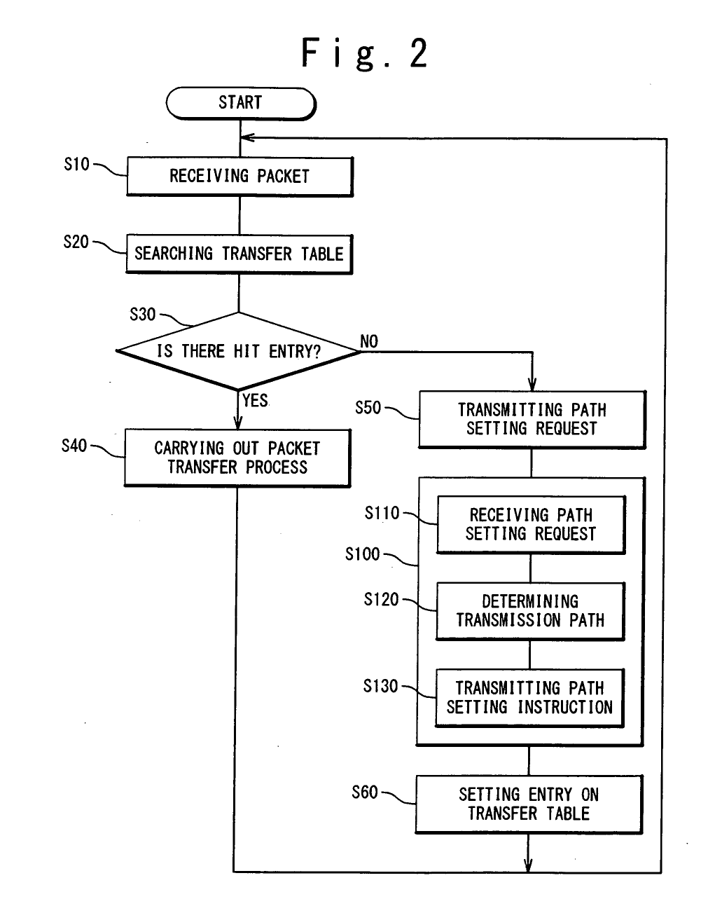

An outline of an operation of the semiconductor integrated circuit system 1 according to the present exemplary embodiment will be explained below. In FIG. 1, a packet transmission from a source core 20A to a destination core 20B will be considered. The source core 20A is a source of a packet, and the destination core 20B is a transmission destination of the packet. FIG. 2 is a flowchart showing the operation of the semiconductor integrated circuit system 1 according to the present exemplary embodiment.

The source core 20A transmits a first packet to the destination core 203. The router 30 in the interconnection network NET (hereinafter referred to as a “first router”) receives the first packet (step S10). The first router 30 searches the transfer table TBL by using information of the received first packet as a search key (step S20).

In the case where there is a hit entry matching the first packet in the transfer table TBL (step S30; Yes), the first router 30 carries out the packet transfer process (step S40). Specifically, the first router 30 transfers the first packet to the output destination designated by the hit entry.

Meanwhile, in the case where there is not a hit entry matching the first packet yet in the transfer table TBL (step S30; No), the first router 30 transmits a “path setting request REQ” to the path control circuit 100 (step S50). The path setting request REQ includes the first packet itself or packet identification information included in the first packet. After that, the process proceeds to a process (step S100) by the path control circuit 100.

Firstly, the path control circuit 100 receives the path setting request REQ transmitted from the first router 30 (step S110). In response to the path setting request REQ, the path control circuit 100 determines a transmission path of the first packet (step S120). On this occasion, the path control circuit 100 can flexibly determine the transmission path of the first packet on the basis of: a state of the whole interconnection network NET; and a characteristic of the first packet.

Subsequently, the path control circuit 100 reflects the determined transmission path to the interconnection network NET. That is, the path control circuit 100 controls the transfer tables 30 of the necessary routers 30 so that the packet transmission along the determined transmission path can be realized. A new entry to be added to the transfer table 30 at that time is referred to a “first transfer entry” below. A “match condition” of the first transfer entry is set so as to match the first packet on the basis of the packet identification information of the first packet included in the path setting request REQ. Meanwhile, an “output link” of the first transfer entry is set so that the first packet can be transferred along the determined transmission path. Then, the path control circuit 100 transmits a “path setting instruction SET”, which instructs to set the first transfer entry on the transfer table TBL, toward the setting-targeted router 30 on the transfer path (step S130). The setting-targeted router 30 includes at least the first router 30. The setting-targeted router 30 may be all of the routers 30 on the above-mentioned determined transmission path.

The setting-targeted router 30 receives the path setting instruction SET. Then, the setting-targeted router 30 sets the first transfer entry on its own transfer table TBL based on the received path setting instruction SET (step S60). After that, the first transfer entry serves as the hit entry which matches the first packet.

Accordingly, the setting-targeted router 30 carries out the packet transfer process based on the transfer table TBL without transmitting the path setting request REQ to the path control circuit 100.

As described above, according to the present exemplary embodiment, the path control circuit 100 determines the packet transmission path from the source core 20A to the destination core 20B. Then, the path control circuit 100 instructs the each router 30 on the determined transmission path to set the transfer table TBL so that the packet transfer can be carried out along the transmission path. In this manner, the determined packet transmission path is reflected to the interconnection network NET. As described above, the packet transmission path in the interconnection network NET is not fixed, and can be dynamically and flexibly controlled by the path control circuit 100. For example, the path control circuit 100 can adequately determine the packet transmission path based on characteristics of an application transmitting the packet (for example, a type such as QoS and Secure). As a result, the characteristic of the application can be widely drawn, for example, improvement of the QoS and improvement of safety.

Additionally, in the present exemplary embodiment, the router 30 is not configured to search and determine the packet transmission path. The determination of the packet transmission path is not carried out individually by the each router 30 but is carried out intensively by one path control circuit 100. The above-mentioned centralized control substantially reduces a circuit area, and additionally simplifies a circuit configuration. This is especially preferable for the interconnection network NET in the semiconductor integrated circuit 10 having a severe restriction of the area, the interconnection network NET being different from a large scale network such as the Internet. In the present exemplary embodiment, it can be said that the packet transmission path can be dynamically control led with the circuit area and the circuit complexity suppressed.

In addition, the path control circuit 100 is typically incorporated in the semiconductor integrated circuit 10 (a semiconductor chip and a semiconductor package). Meanwhile, the path control circuit 100 may be provided outside the semiconductor integrated circuit 10. In that case, the outside path control circuit 100 is connected to the semiconductor integrated circuit 10 to be able to communicate with each other, and transmits and receives the above-mentioned path setting request REQ and path setting instruction SET to and from the each router 30 in the semiconductor integrated circuit 10

### 2. First Exemplary Embodiment

### 2-1. Overall Configuration

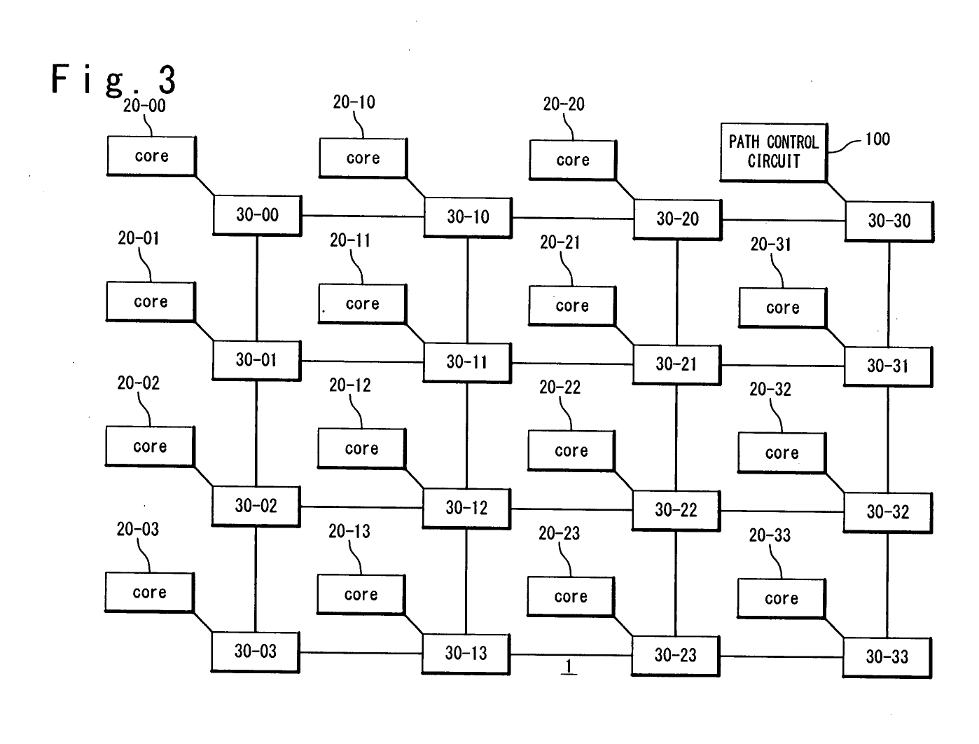

FIG. 3 is a block diagram showing a configuration example of the semiconductor integrated circuit system 1 according to a first exemplary embodiment. As shown in FIG. 3, in the present exemplary embodiment, routers 30-00 to 30-33 are arranged in a matrix shape, and thus the interconnection network NET is configured. Cores 20-00 to 20-33 (except the core 20-30) are connected to the routers 30-00 to 30-33 (except the router 30-30), respectively. The path control circuit 100 is connected to the router 30-30. Meanwhile, the configuration shown in FIG. 3 is merely one example, and accordingly the number of the cores, the number of the routers, and the topology of the interconnection network are arbitrary.

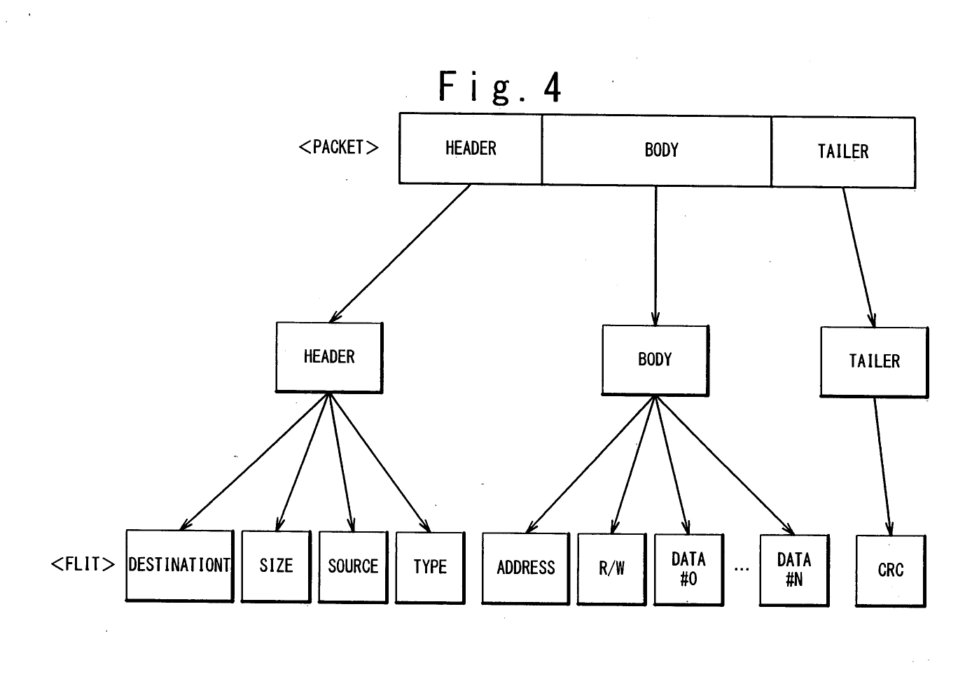

FIG. 4 shows a typical configuration of the packet transmitted by the interconnection network NET in the semiconductor integrated circuit 10. The packet is separated in three parts, a “header” as control information, a “body” as access information to the destination core, and a “tailer” for securing validity of the packet. Each of the parts can be further separated into smaller units called a flit. For example, the “header” includes a “destination node”, a “packet size”, a “source node”, a “packet type”, and the like as the flits. The “packet type” is information showing characteristics of an application packet such as a QoS-oriented type and a secure-oriented type. In the case where the destination core 20B has a region that can be designated by an access address, for example, in the case where the destination core 20B is a memory, the “body” includes an “access address”, an “access type (read/write)”, “write data”, and the like as the flits. The “tailer”, for example, includes a “CRC (Cyclic Redundancy Code)” of the whole of the packet as the flit.

### 2-2. Router 30

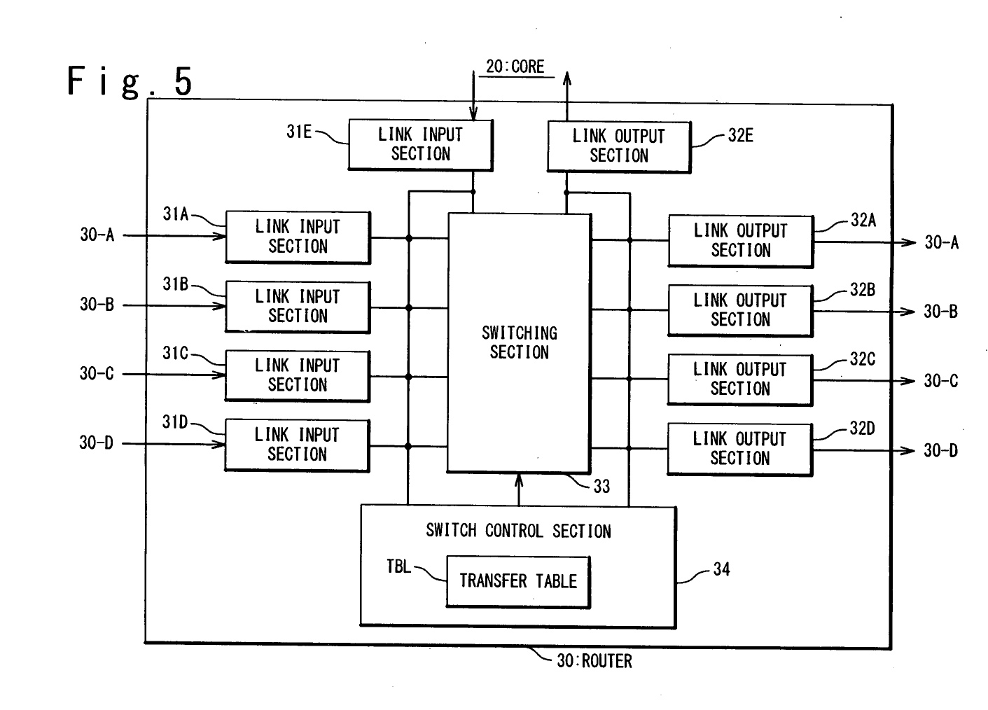

FIG. 5 is a block diagram showing a configuration example of the router 30 according to the present exemplary embodiment. The router 30 includes a plurality of link input sections 31, a plurality of link output sections 32, a switching section 33, and a switch control section 34.

The link input section 31 is an input port connected to an external link, and receives data from an adjacent node (the adjacent core 20 and the adjacent router 30). The link output section 32 is an output port connected to an external link, and outputs data to the adjacent node. In an example of FIG. 5, the link input sections 31-i and the link output sections 32i (i=A, B, C, and D) are connected to the adjacent router 30i, and the link input section 31E and the link output section 32E are connected to the core 20.

The switching section 33 is connected to all of the link input sections 31 and the link output sections 32. The switching section 33 connects the designated link input section 31 and the designated link output section 32 with each other, and then transfers the packet from the link input section 31 to the link output section 32. The switch control section 34 is a control section to carry out the designating.

The switch control section 34 stores the above-mentioned transfer table TBL. When the packet is supplied to the some link input section 31, the switch control section 34 receives the packet. Then, the switch control section 34 searches the transfer table TBL by using information of the received packet as a search key (step S20). In the case where there is a hit entry matches the received packet in the transfer table TBL (step S30; Yes), the switch control section 34 connects the link input section 31 to which the above-mentioned packet is inputted with the link output section 32 designated by the hit entry. As a result, the received packet is transferred to the designated link output section 32 (step S40). On the other hand, in the case where there is not a hit entry matches the received packet in the transfer table TBL (step S30; No), the switch control section 34 transmits the path setting request REQ to the path control circuit 100 (step S50). Additionally, in the case of receiving the path setting instruction SET, the switch control section 34 carries out the setting of the transfer table TBL based on the received path setting instruction SET (step S60).

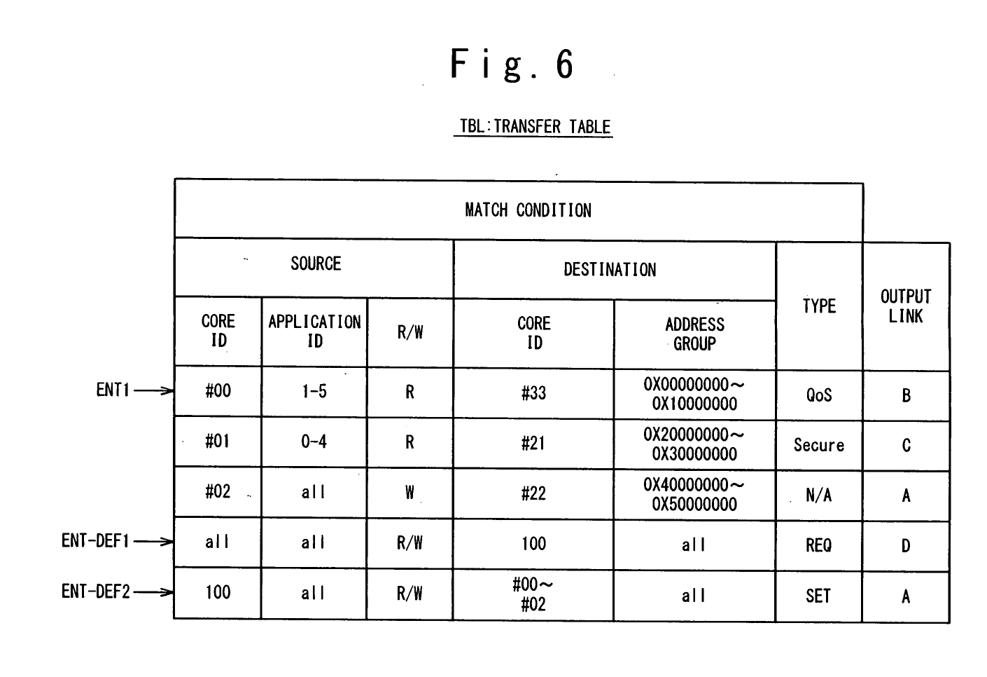

FIG. 6 shows one example of the transfer table TBL in the present exemplary embodiment. In the example of FIG. 6, the match condition includes a “source core ID (an identifier of the source core 20A)”, an “application ID (an identifier of an application that is a source of the packet on the source core 20A)”, an “access type (read/write)”, an “destination core ID (an identifier of the destination core 20B)”, an “address group”, and a “packet type”.

The “address group” is access addresses grouped within a predetermined range. The access address is designated in the packet in the case where the destination core 20B is, for example, a memory (refer to FIG. 4). The foregoing access address is information uniquely used in the interconnection network of the semiconductor integrated circuit 10, the connection network being different from the internet. However, since the number of the memory access addresses is extraordinary large, the access addresses within a predetermined range is “grouped” as shown in FIG. 6. In this manner, the information amount is reduced, and accordingly a memory resource is saved.

The “packet type” is information showing the characteristics of the application packet such as the QoS-oriented type and the secure-oriented type (refer to FIG. 4). The inclusion of the above-mentioned packet type in the match condition of the transfer table. TBL means that the packet transmission path is determined on the basis of the characteristics of the application (described below).

Additionally, in the present exemplary embodiment, the transfer table TBL of the each router 30 includes a “default entry” used for transferring the above-mentioned path setting request REQ and the path setting instruction SET. More specifically, a first default entry ENT-DEF1 matches the path setting request. REQ and is used for transferring the path setting request REQ. In the each router 30, the first default entry ENT-DEF1 is set so as to transfer the path setting request REQ to the path control circuit 100. In this manner, the path setting request REQ transmitted from the some router 30 reaches the path control circuit 100. On the other hand, a second default entry ENT-DEF2 matches the path setting instruction SET and is used for transferring the path setting instruction SET. In the each router 30, the second default entry ENT-DEF2 is set so as to transfer the path setting instruction SET to the predetermined router 30. In this manner, the path setting instruction SET transmitted from the path control circuit 100 reaches the desired router 30. Meanwhile, it is preferred that these default entries are preliminarily set to all of the routers 30 on the interconnection network NET.

### 2-3. Path Control Circuit 100

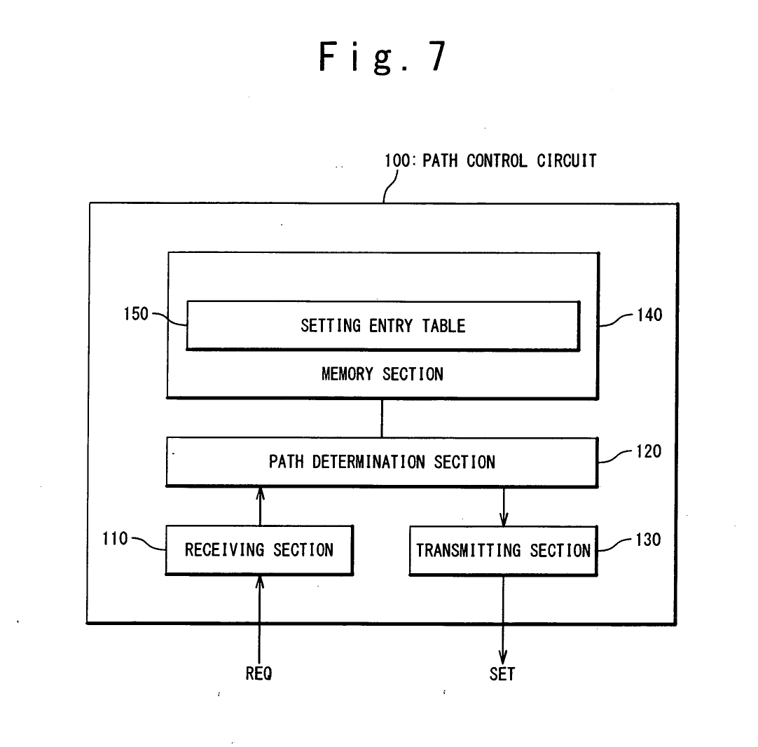

FIG. 7 is a block diagram showing a configuration example of the path control circuit 100 according to the present exemplary embodiment. The path control circuit 100 includes a receiving section 110, a path determination section 120, a transmitting section 130, and a memory section (memory device) 140. In the memory section 140, a setting entry table 150 is stored.

The receiving section 110 receives the path setting request REQ, and passes the path setting request REQ to the path determination section 120 (step S110). In response to the path setting request REQ, the path determination section 120 determines the packet transmission path, and additionally depending on that, designs a transfer entry to beset to the setting-targeted router 30 (step S120). Moreover, the path determination section 120 creates the path setting instruction SET for instructing to set the transfer entry, and passes the path setting instruction SET to the transmitting section 130. The transmitting section 130 transmits the path setting instruction SET to the setting-targeted router 30 (step S130).

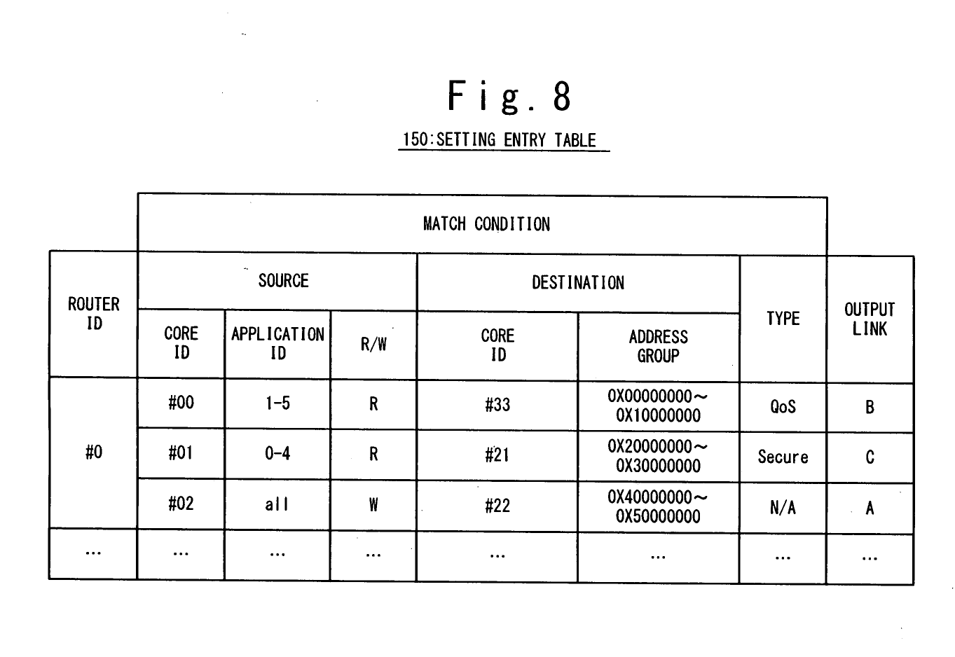

In addition, the path determination section 120 stores the designed transfer entry into the setting entry table 150 in the memory section 140. FIG. 8 shows one example of the setting entry table 150. As shown in FIG. 8, the setting entry table 150 includes the same information as that of the transfer table TBL of the router 30 shown in FIG. 6. Meanwhile, an identifier (a router ID) of the router 30 to which a transfer entry is set is added. In addition, the default entries ENT-DEF1 and ENT-DEF2 may be omitted.

As shown in FIGS. 6 and 8, according to the present exemplary embodiment, the access address at the destination core 20B (for example, a memory access address) is used as a part of the match condition. However, indetermination of the packet transmission path, the path determination section 120 groups the access addresses within a predetermined range, and incorporates the grouped access addresses as an “address group” into the match condition. That is because the number of the access addresses in the semiconductor integrated circuit 10 is extraordinary large and because when the addresses are directly used, explosion of an information amount is caused. When the addresses are aggregated to be small, the information amount is reduced, and accordingly a memory resource can be saved.

In addition, according to the present exemplary embodiment, the path determination section 120 adequately determines the packet transmission path based on the characteristics (the packet type such as the QoS and the Secure) of the application that transmits the packet. As the result, the characteristics of the application can be widely drawn, for example, improvement of the QoS, improvement of safety, and improvement of real-time process.

### 2-4. Operation Example

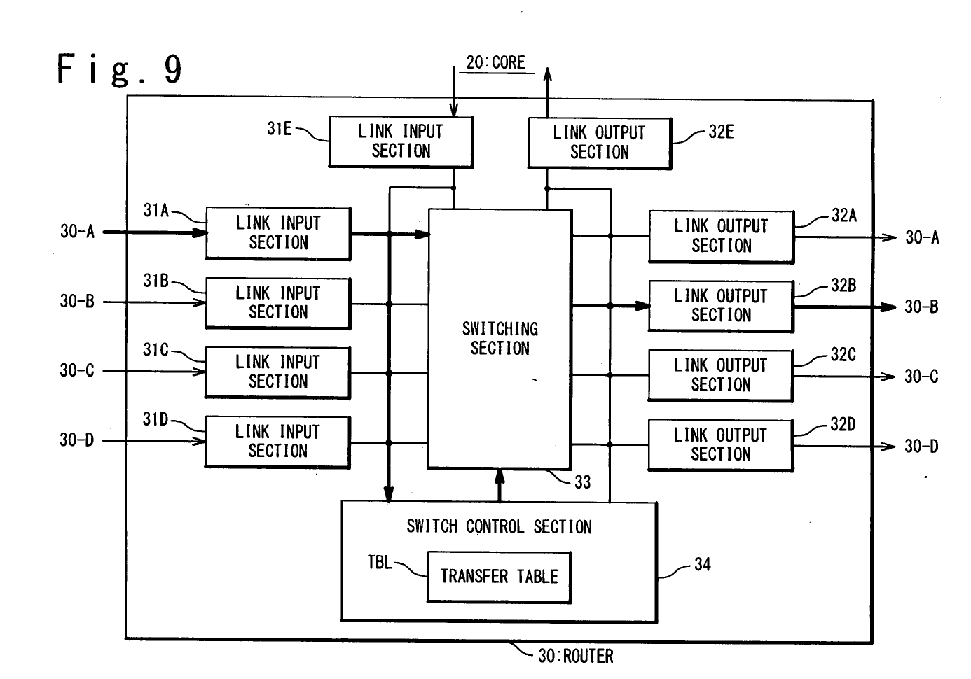

FIG. 9 conceptually shows one example of an operation of the router 30 in the case where there is the hit entry in the transfer table TBL. The link input section 31A receives the packet from the adjacent router 30-A. The link input section 31A transmits the received packet to the switching section 33 and the switch control section 34. The switch control section 34 searches the transfer table TBL to find the hit entry matching the received packet. For example, it is assumed that the first entry ENT1 in FIG. 6 is the hit entry. The first entry ENT1 designates the link output section 32B as an output destination. In this case, the switch control section 34 controls the switching section 33 so as to connect the link input section 31A to the designated link output section 32B. The switching section 33 outputs the packet received from the link input section 31A to the link output section 32B. The packet is outputted from the link output section 32B to the adjacent router 30-B.

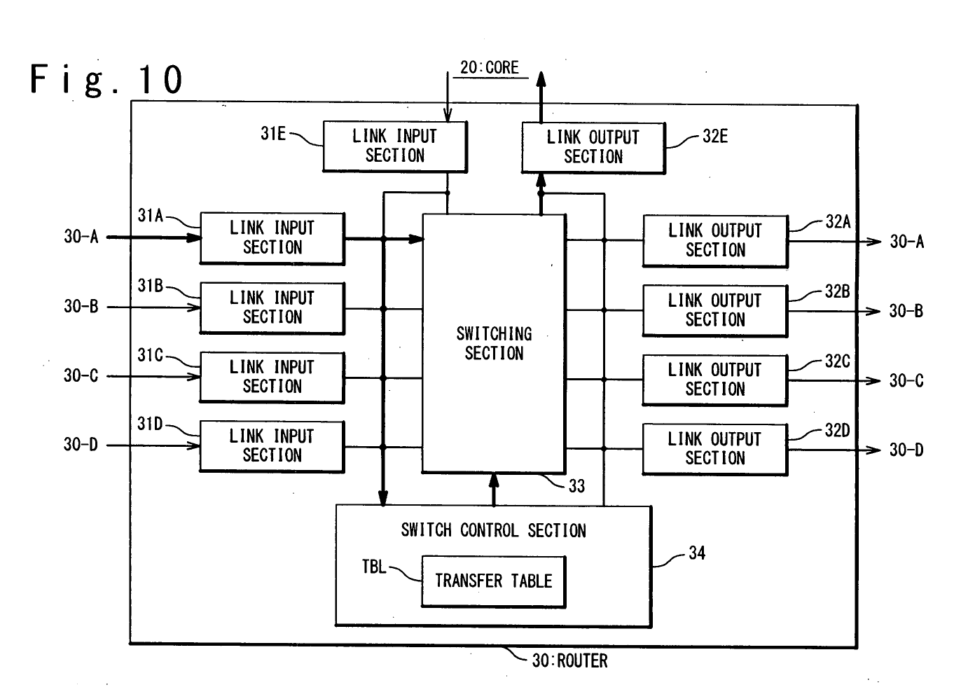

FIG. 10 conceptually shows another example of the operation of the router 30 in the case where there is the hit entry in the transfer table TBL. The link input section 31A receives the packet from the adjacent router 30-A. The link input section 31A transmits the received packet to the switching section 33 and the switch control section 34. The switch control section 34 searches the transfer table TEL to find the hit entry matching the received packet. In the example, the hit entry designates the link output section 32E linked to the core 20 as an output destination. In this case, the switch control section 34 controls the switching section 33 so as to connect the link input section 31A to the designated link output section 32E. The switching section 33 outputs the packet received from the link input section 31A to the link output section 32E. The packet is outputted from the link output section 32E to the core 20.

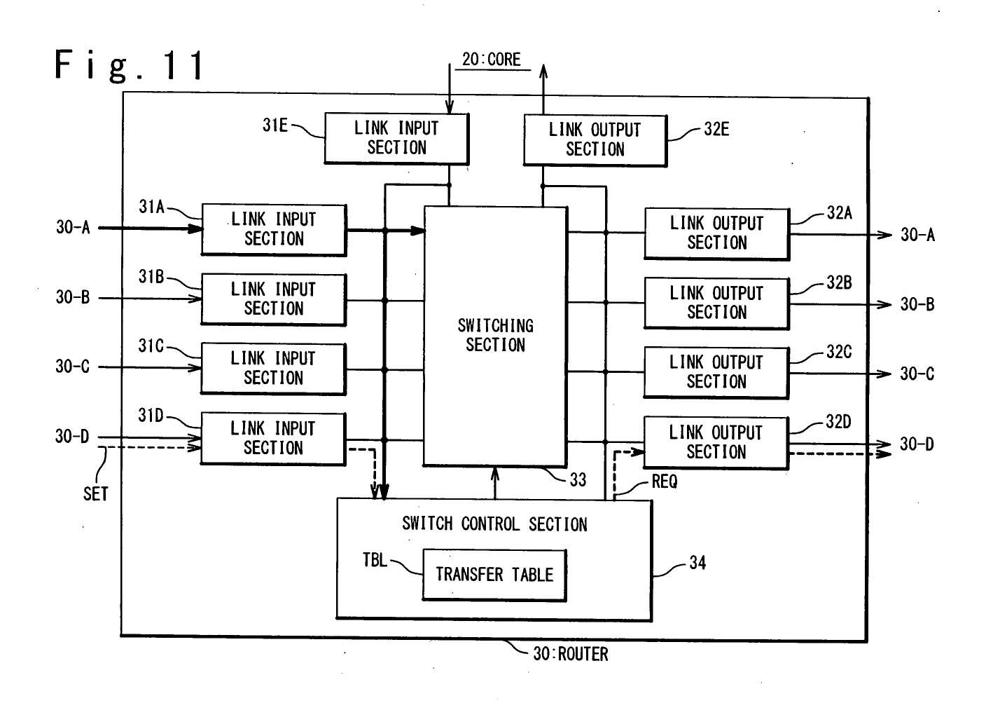

FIG. 11 conceptually shows one example of the operation of the router 30 in the case where there is not the hit entry in the transfer table TBL. The link input section 31A receives the packet from the adjacent router 30-A. The link input section 31A transmits the received packet to the switching section 33 and the switch control section 34. The switch control section 34 searches the transfer table TBL, but outputs the path setting request REQ because there is not the hit entry. For example, the path setting request REQ is outputted to the adjacent router 30-D via the link output section 32D.

Upon receiving the path setting request REQ, the router 30-D transfers the path setting request REQ based on the first default entry ENT-DEF1. By repeating the same transfer operation, the path setting request REQ is relayed to finally reach the path control circuit 100. In response to the path setting request REQ, the path control circuit 100 determines the packet transmission path, and transmits the path setting instruction SET to the adjacent router 30. Based on the second default entry ENT-DEF2, the router 30 that received the path setting instruction SET transfers the path setting instruction SET. By repeating the same transfer operation, the path setting instruction SET reaches the router 30 that transmitted the path setting request REQ at the beginning.

For example, as shown in FIG. 11, the path setting instruction SET is supplied to the link input section 31D. The link input section 31D transmits the received path setting instruction SET to the switch control section 34. Based on the path setting instruction SET, the switch control section 34 carries out the setting of the transfer table TBL. After that, in the same manner as that of the case shown in the above-mentioned FIGS. 9 and 10, the packet transfer is carried out without inquiring to the path control circuit 100.

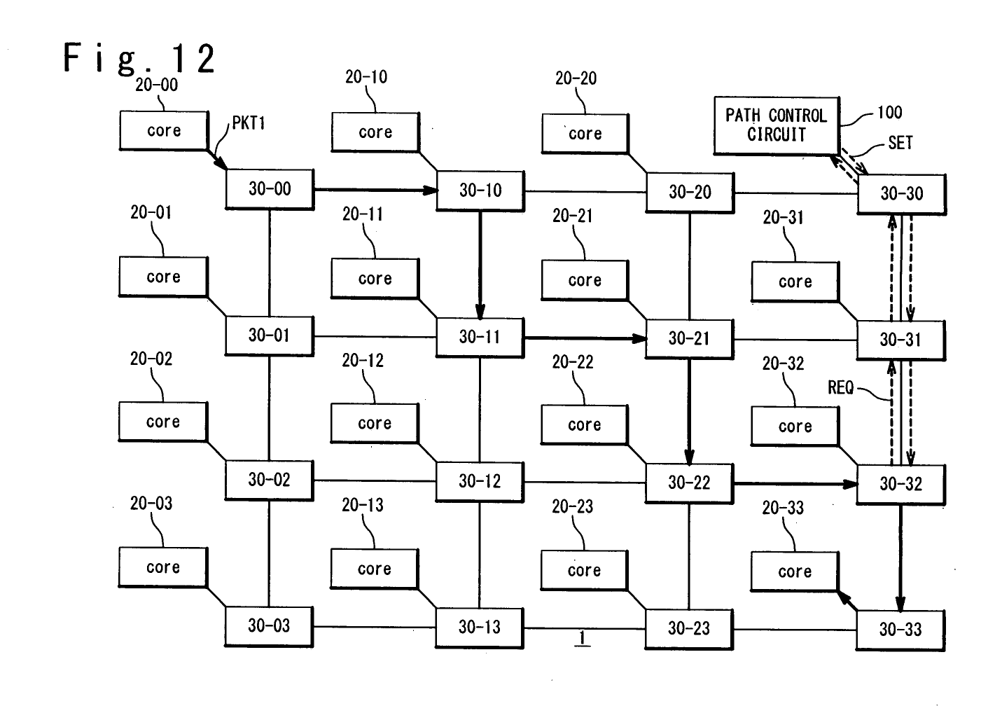

FIG. 12 shows one example of the case where a packet PKT1 is transmitted from the source core 20-00 to the destination core 20-33. In the example of FIG. 12, each of the routers 30 that received the packet PKT1 carries out the inquiring to the path control circuit 100 one by one. For example, when the router 30-32 is first received the packet PKT1, the hit entry that hits the packet PKT1 is not set to the router 30-32 yet. Accordingly, the router 30-32 transmits the path setting request REQ to the path control circuit 100. The path setting request REQ reaches the path control circuit 100 via the routers 30-31 and 30-30. The path setting instruction SET responding to the path setting request REQ reaches the router 30-32 via the routers 30-30 and 30-31. Based on the path setting instruction SET, the router 30-32 sets the transfer entry related to the packet PKT1 to its own transfer table TBL. The operations of other routers 30 are the same as that of the example. In this manner, the packet PKT1 transmitted from the source core 20-00 reaches the destination core 20-33 via the routers 30-00, 30-10, 30-11, 30-21, 30-22, 30-32, and 30-33. The packet transmission path is not fixed, and is flexibly determined by the path control circuit 100 on the basis of the type and the like of the packet PKT1.

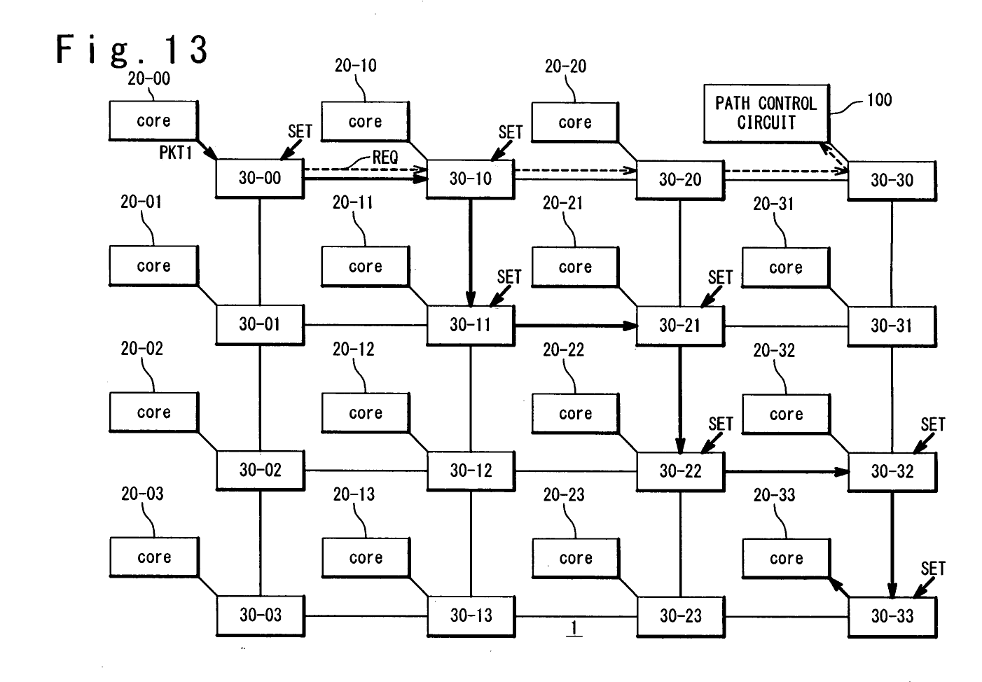

FIG. 13 shows another example of the case where the packet PKT1 is transmitted from the source core 20-00 to the destination core 20-33. In the example of FIG. 13, the setting of the transfer table TBL is collectively carries out to all of the routers 30 on the transmission path of the packet PKT1. Specifically, at first, the router 30-00 receives the packet PKT1 from the source core 20-00. Since there is not the hit entry, the router 30-00 transmits the path setting request REQ to the path control circuit 100. The path setting request REQ reaches the path control circuit 100 via the routers 30-10, 30-20, and 30-30. The path control circuit 100 determines the packet transmission path from the router 30-00 to the destination core 20-33. In the present example, the path control circuit 100 determines all of the routers 30-00, 30-10, 30-11, 30-21, 30-22, 30-32, and 30-33 on the determined packet transmission path as the “setting-targeted routers”. Then, the path control circuit 100 collectively transmits the path setting instruction SET to each setting-targeted router 30. The path setting instructions SET reach the setting-targeted routers 30, respectively, via the respective reply paths. Based on the received path setting instruction SET, each of the setting-targeted routers 30 sets the transfer entry related to the packet PKT1 to its own transfer table TBL. Since the path setting process is completed by the path control circuit 100 at one time, thereby reducing loads of the path control circuit 100 and the network, thus the present example is preferable.

### 3. Second Exemplary Embodiment

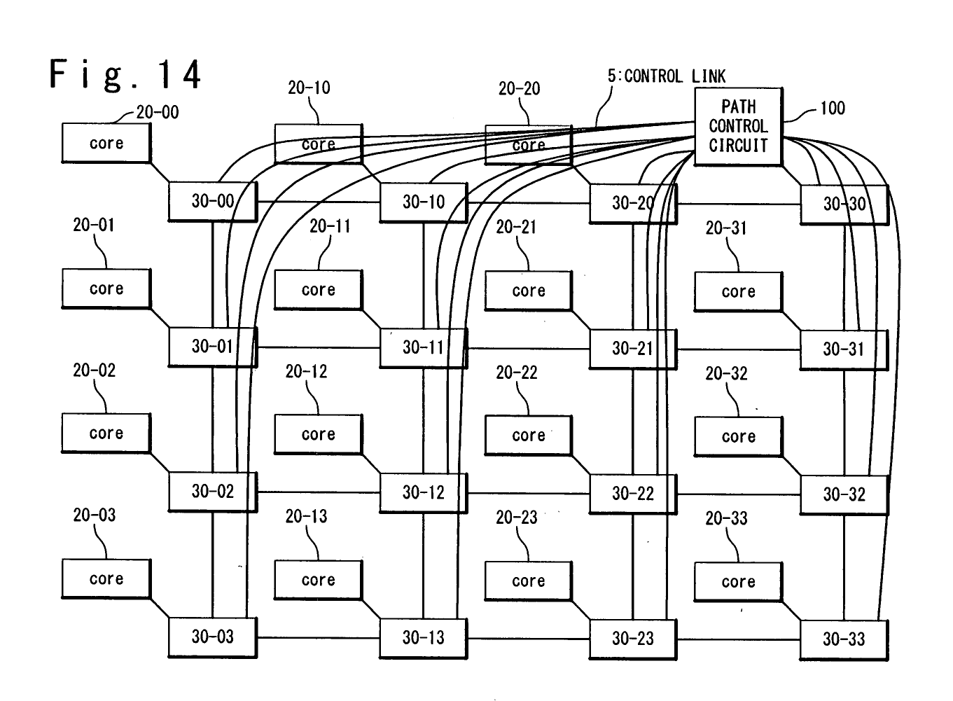

FIG. 14 is a block diagram showing a configuration example of the semiconductor integrated circuit system 1 according to a second exemplary embodiment. Repeated descriptions made in the above-described first exemplary embodiment are omitted. According to the present exemplary embodiment, the path control circuit 100 is directly connected to each of the routers 30-00 and 30-33 via a dedicated control link 5. In this case, the above-mentioned path setting request REQ is directly transmitted from the each router 30 to the path control circuit 100 via the control link 5. In addition, the above-mentioned path setting instruction SET is directly transmitted from the path control circuit 100 to the setting-targeted router 30 via the control link 5.

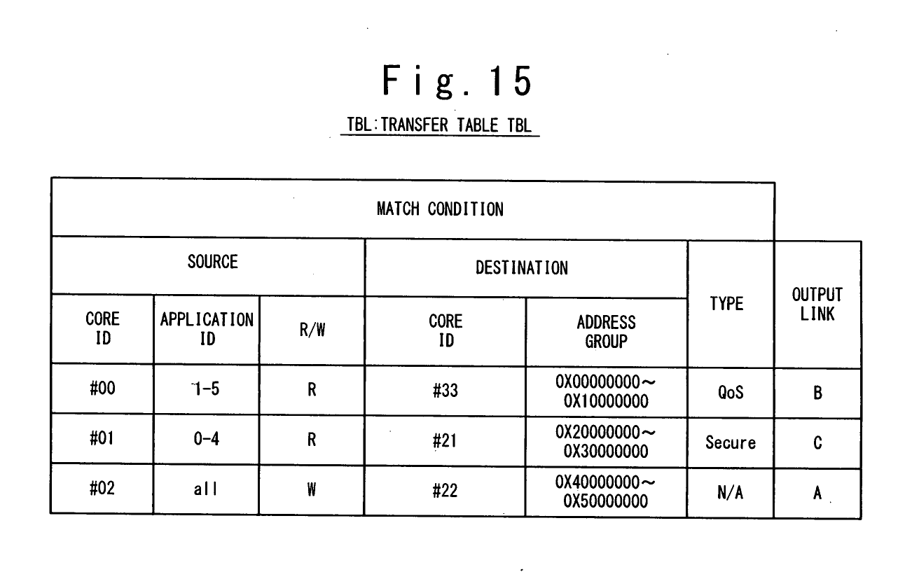

Accordingly, in the present exemplary embodiment, as shown in FIG. 15, the default entries ENT-DEF1 and ENT-DEF2 can be omitted from the transfer table TBL. In this manner, the size of the transfer table TEL of the each router 30 can be reduced. In addition, since the transferring of the path setting request REQ and the path setting instruction SET is not required, the processing load applied to the each router 30 can be also reduced. Meanwhile, the above-described configuration can be realized because a wiring line cost is small in the case of the semiconductor integrated circuit 10 as compared with the case of the Internet having a large-scale network.

While the invention has been particularly shown and described with reference to exemplary embodiments thereof, the invention is not limited to these exemplary embodiments. It will be understood by those of ordinary skill in the art that various changes in form and details may be made therein without departing from the spirit and scope of the present invention as defined by the claims.

The whole or part of the exemplary embodiments disclosed above can be described as, but not limited to, the following supplementary notes.

### (Supplementary Note 1)

A semiconductor integrated circuit system including:

a semiconductor integrated circuit; and

a path control circuit,

wherein the semiconductor integrated circuit includes:

a plurality of cores configured to be connected with each other via an interconnection network, and

a plurality of routers configured to be arranged on the interconnection network,

wherein each of the plurality of routers includes a transfer table,

wherein each entry of the transfer table designates an output destination of a packet which matches a match condition,

wherein the each router searches the transfer table upon receiving a reception packet, and, when there is a hit entry which matches the reception packet in the transfer table, the each router transfers the reception packet to an output destination designated by the hit entry,

wherein the plurality of cores include a source core and a destination core,

wherein the path control circuit dynamically determines a transmission path of a packet from the source core to the destination core, and instructs each router on the determined transmission path to set the transfer table so that a packet transmission is carried out along the determined transmission path.

### (Supplementary Note 2)

The semiconductor integrated circuit system according to Supplementary note 1, wherein the path control circuit determines the transmission path based on characteristics of an application to transmit the packet from the source core to the destination core, and

wherein the match condition of the transfer table includes the characteristics of the application.

### (Supplementary Note 3)

The semiconductor integrated circuit system according to Supplementary note 1 or 2, wherein the destination core includes a region that can be designated by an access address,

wherein the path control circuit groups access addresses including the access address within a predetermined range when determining the transmission path, and

wherein the match condition of the transfer table includes the grouped access addresses.

### (Supplementary Note 4)

The semiconductor integrated circuit system according to anyone of Supplementary notes 1 to 3, wherein the path control circuit is incorporated in the inside of the semiconductor integrated circuit.

### (Supplementary Note 5)

The semiconductor integrated circuit system according to any one of Supplementary notes 1 to 4, wherein when a first packet is transmitted from the source core to the destination core, the path control circuit determines the transmission path of the first packet, and instructs a setting-targeted router on the determined transmission path to set a first transfer entry to the transfer table,

wherein the match condition of the first transfer entry is set so as to matches the first packet, and

wherein the output destination of the first transfer entry is set so that the first packet is transferred along the determined transmission path.

### (Supplementary Note 6)

The semiconductor integrated circuit system according to Supplementary note 5, wherein a first router of the plurality of routers searches the transfer table upon receiving the first packet,

wherein when there is not a hit entry matching the first packet in the transfer table yet, the first router transmits a path setting request including information of the first packet to the path control circuit,

wherein the path control circuit determines the transmission path of the first packet in response to the path setting request, and transmits a path setting instruction instructing to set the first transfer entry toward the setting-targeted router, and

wherein the first router included in the setting-targeted router sets the first transfer entry to the transfer table based on the path setting instruction.

### (Supplementary Note 7)

The semiconductor integrated circuit system according to Supplementary note 6, wherein the setting-targeted router indicates each of all routers on the determined transmission path,

wherein the path control circuit collectively transmits the path setting instruction to the setting-targeted router, and

wherein the setting-targeted router sets the first transfer entry to the transfer table based on the path setting instruction.

### (Supplementary Note 8)

The semiconductor integrated circuit system according to Supplementary note 6 or 7, wherein the path control circuit is directly connected to each of the plurality of routers via a control link, and

wherein the path setting request and the path setting instruction are transmitted via the control link.

### (Supplementary Note 9)

The semiconductor integrated circuit system according to Supplementary note 6 or 7, wherein the transfer table of the each router includes:

a first default entry matching the path setting request, for transferring the path setting request to the path control circuit, and

a second default entry matching the path setting instruction, for transferring the path setting instruction to a predetermined router,

wherein upon receiving the path setting requirement, the each router transfers the path setting request to the output destination designated by the first default entry, and

wherein upon receiving the path setting instruction, the each router transfers the path setting instruction to the output destination designated by the second default entry.

### (Supplementary Note 10)

A packet transmission control method in a semiconductor integrated circuit, wherein the semiconductor integrated circuit includes:

a plurality of cores configured to be connected with each other via an interconnection network; and

a plurality of routers configured to be arranged on the interconnection network,

wherein each of the plurality of routers includes a transfer table,

wherein each entry of the transfer table designates an output destination of a packet which matches a match condition,

wherein the each router searches the transfer table upon receiving a reception packet, and, when there is a hit entry which matches the reception packet in the transfer table, transfers the reception packet to an output destination designated by the hit entry, and

wherein the plurality of cores include a source core and a destination core,

the packet transmission method includes:

dynamically determining a transmission path of a packet from the source core to the destination core;

instructing each router on the determined transmission path to set the transfer table so that a packet transmission can be carried out along the determined transmission path; and

the each router carrying out the packet transmission based on the transfer table.

This application is based upon and claims the benefit of priority from Japanese patent application No. 2010-087876 filed on Apr. 6, 2010, the disclosure of which is incorporated herein in its entirety by reference.

1. A semiconductor integrated circuit system comprising:
a semiconductor integrated circuit; and
a path control circuit,
wherein said semiconductor integrated circuit includes:
a plurality of cores configured to be connected with each other via an interconnection network, and
a plurality of routers configured to be arranged on said interconnection network,
wherein each of said plurality of routers includes a transfer table,
wherein each entry of said transfer table designates an output destination of a packet which matches a match condition,
wherein said each router searches said transfer table upon receiving a reception packet, and, when there is a hit entry which matches said reception packet in said transfer table, said each router transfers said reception packet to an output destination designated by said hit entry,
wherein said plurality of cores include a source core and a destination core,
wherein said path control circuit dynamically determines a transmission path of a packet from said source core to said destination core, and instructs each router on said determined transmission path to set said transfer table so that a packet transmission is carried out along said determined transmission path.

2. The semiconductor integrated circuit system according to claim 1, wherein said path control circuit determines said transmission path based on characteristics of an application to transmit said packet from said source core to said destination core, and
wherein said match condition of said transfer table includes said characteristics of said application.

3. The semiconductor integrated circuit system according to claim 1, wherein said destination core includes a region that can be designated by an access address,
wherein said path control circuit groups access addresses including said access address within a predetermined range when determining said transmission path, and
wherein said match condition of said transfer table includes said grouped access addresses.

4. The semiconductor integrated circuit system according to claim 1, wherein said path control circuit is incorporated in the inside of said semiconductor integrated circuit.

5. The semiconductor integrated circuit system according to claim 1, wherein when a first packet is transmitted from said source core to said destination core, said path control circuit determines said transmission path of said first packet, and instructs a setting-targeted router on said determined transmission path to set a first transfer entry to said transfer table,
wherein said match condition of said first transfer entry is set so as to matches said first packet, and
wherein said output destination of said first transfer entry is set so that said first packet is transferred along said determined transmission path.

6. The semiconductor integrated circuit system according to claim 5, wherein a first router of said plurality of routers searches said transfer table upon receiving said first packet,
wherein when there is not a hit entry matching said first packet in said transfer table yet, said first router transmits a path setting request including information of said first packet to said path control circuit,
wherein said path control circuit determines said transmission path of said first packet in response to said path setting request, and transmits a path setting instruction instructing to set said first transfer entry toward said setting-targeted router, and
wherein said first router included in said setting-targeted router sets said first transfer entry to said transfer table based on said path setting instruction.

7. The semiconductor integrated circuit system according to claim 6, wherein said setting-targeted router indicates each of all routers on said determined transmission path,
wherein said path control circuit collectively transmits said path setting instruction to said setting-targeted router, and
wherein said setting-targeted router sets said first transfer entry to said transfer table based on said path setting instruction.

8. The semiconductor integrated circuit system according to claim 6, wherein said path control circuit is directly connected to each of said plurality of routers via a control link, and
wherein said path setting request and said path setting instruction are transmitted via said control link.

9. The semiconductor integrated circuit system according to claim 6, wherein said transfer table of said each router includes:
a first default entry matching said path setting request, for transferring said path setting request to said path control circuit, and
a second default entry matching said path setting instruction, for transferring said path setting instruction to a predetermined router,
wherein upon receiving said path setting requirement, said each router transfers said path setting request to said output destination designated by said first default entry, and
wherein upon receiving said path setting instruction, said each router transfers said path setting instruction to said output destination designated by said second default entry.

10. A packet transmission control method in a semiconductor integrated circuit, wherein said semiconductor integrated circuit includes:
a plurality of cores configured to be connected with each other via an interconnection network; and
a plurality of routers configured to be arranged on said interconnection network,
wherein each of said plurality of routers includes a transfer table,
wherein each entry of said transfer table designates an output destination of a packet which matches a match condition,
wherein said each router searches said transfer table upon receiving a reception packet, and, when there is a hit entry which matches said reception packet in said transfer table, transfers said reception packet to an output destination designated by said hit entry, and
wherein said plurality of cores include a source core and a destination core,
said packet transmission method includes:
dynamically determining a transmission path of a packet from said source core to said destination core;
instructing each router on said determined transmission path to set said transfer table so that a packet transmission can be carried out along said determined transmission path; and
said each router carrying out said packet transmission based on said transfer table.
